(19) United States
(12) Patent Application Publication
(10) Pub. No.: US 2018/0094605 A1
(43) Pub. Date: Apr. 5, 2018

(54) TURBOFAN ENGINE FOR A CIVIL SUPERSONIC AIRCRAFT

(71) Applicant: Rolls-Royce Deutschland Ltd & Co KG, Blankenfelde-Mahlow (DE)

(72) Inventors: Knut ROSENAU, Herzfelde (DE); James Robert MCLEAVY HILL, Berlin (DE)

(21) Appl. No.: 15/720,935

(22) Filed: Sep. 29, 2017

(30) Foreign Application Priority Data
Oct. 4, 2016 (DE) 10 2016 118 783.6

(51) Int. Cl. F02K 1/09; F02K 1/44; F02K 1/60; F02K 1/76; F02K 3/06

(52) U.S. Cl. CPC F02K 1/09; F02K 1/44; F02K 3/06; F02K 1/763; F02K 1/60

(57) ABSTRACT

A turbofan engine for a civil supersonic aircraft, including: an engine intake; a multi-stage fan that is arranged behind the engine intake; a core engine that comprises a compressor, a combustion chamber and a turbine; a primary flow channel that leads through the core engine; a secondary flow channel that leads past the core engine; an adjustable converging-diverging thrust nozzle that forms a nozzle throat area and a nozzle outlet area, wherein at least the nozzle throat area is adjustable; and a thrust reverser that is integrated in the adjustable converging-diverging thrust nozzle.

### REFERENCE TO RELATED APPLICATION

This application claims priority to German Patent Application No. 10 2016 118 783.6 filed on Oct. 4, 2016, the entirety of which is incorporated by reference herein.

### BACKGROUND

The invention relates to a turbofan engine for a civil supersonic aircraft.

After civil supersonic flight suffered a setback following the termination of the operation of the supersonic passenger plane “Concorde”, lately the interest in the development of supersonic aircrafts for the civil area, and correspondingly also the interest in efficient aircraft engines suitable for supersonic operation, has again been rising.

The engine RB199 that is realized in the Tornado fighter jet comprises a three-stage fan and an adjustable thrust nozzle with a thrust reverser. Adjustable converging-diverging thrust nozzles are known from the engine EJ200 of the Eurofighter fighter jet engine, for example. However, engines for a supersonic operation as they are known from military technology cannot be used in the civil area, since the requirements, for example with regard to engine noise and fuel consumption, are not sufficient.

There is a need to provide an efficient turbofan engine that is suitable for supersonic operation.

### SUMMARY

A turbofan engine for a civil supersonic aircraft is provided. It comprises an engine intake, which is provided and configured for supersonic flight and slows down the inflowing air to subsonic velocity. It is further provided a multi-stage, for example a double-stage or a three-stage fan that is arranged behind the engine intake. The engine comprises a core engine that has a compressor, a combustion chamber, and a turbine. A primary flow channel that leads through the core engine and a secondary flow channel that leads past the core engine are provided.

The turbofan engine further comprises an adjustable converging-diverging thrust nozzle that forms the rear end of the engine and has a nozzle throat area and a nozzle outlet area, wherein at least the nozzle throat area is adjustable. What is referred to as the nozzle throat area here is the narrowest cross-sectional area of the thrust nozzle, and what is referred to as the nozzle outlet area is the cross-sectional area at the rear end of the thrust nozzle. It is further provided a thrust reverser that is integrated into the adjustable converging-diverging thrust nozzle, i.e., at least some of the components of the thrust reverser are formed by the components of the thrust nozzle.

The nozzle outlet area can also be adjustable. In a simplified embodiment of the invention, the nozzle outlet area can be embodied to be non-adjustable.

What is facilitated by using a converging-diverging thrust nozzle is, among other things, that the efficiency of the compressor is set based on the modification of the nozzle throat area and thus of the conicity of the thrust nozzle. The velocity of the gas flow can be adjusted through the modification of the nozzle outlet area, and thus the divergence at the nozzle outlet. The additional provision of a thrust reverser and its integration into the thrust nozzle facilitates a short brake path of the aircraft with low structural loads. In this manner, the invention in total provides an efficient engine for supersonic flight operation.

The turbofan engine is for example designed for a flight velocity range of Ma 1.0 to Ma 3.0, in particular of Ma 1.2 to Ma 1.8 and for a take-off thrust range of 44.482 N (10.000 lbf) to 444.820 N (100.000 lbf), in particular for a take-off thrust range of 66.723 N (15.000 lbf) to 133.446 N (30.000 lbf).

According to one embodiment of the invention, the thrust nozzle has a frontal non-adjustable area and a rear adjustable area. Here, the rear adjustable area comprises adjusting mechanisms for adjusting the nozzle throat area and the nozzle outlet area. According to one embodiment of the invention, the thrust reverser is integrated into the frontal non-adjustable area of the thrust nozzle.

The attributes “frontal” and “rear” are to be understood with respect to the air flow direction in the engine. Therefore, the attribute “frontal” means “upstream”, and the attribute “rear” means “downstream”.

In one embodiment of the invention, it is provided that the thrust nozzle comprises an inner wall and an outer wall, wherein the inner wall is facing towards the gas flow and delimitates the flow path by the thrust nozzle. The outer wall borders the environment. It is provided that the frontal upstream non-adjustable area of the thrust nozzle comprises a frontal non-adjustable area of the outer wall and a frontal non-adjustable area of the inner wall. The rear downstream adjustable area of the thrust nozzle comprises a rear adjustable area of the outer wall and a rear adjustable area of the inner wall. Thus, the inner wall as well as the outer wall are embodied so as to be movable in the rear area. Further, it is provided that the rear adjustable area of the inner wall has a frontal adjustable inner wall area and a rear adjustable inner wall area. The inner wall is thus additionally divided into two areas in its rear adjustable area.

The rear adjustable inner wall area is connected to the frontal adjustable inner wall area by means of hinge joints, for example. The frontal adjustable inner wall area is connected to the frontal non-adjustable area of the inner wall, also for example by means of hinge joints. This also applies to the connection between the rear adjustable area of the outer wall and the frontal non-adjustable area of the outer wall.

In one embodiment of the invention, it is provided that the thrust nozzle is provided with a sound-absorbing cladding (also referred to as “noise liner”) in the frontal non-adjustable area of the inner wall. In this manner, the engine noise is considerably reduced. A sound-absorbing cladding can also be formed in other sections of the engine. For instance, it can be provided that the engine intake is also provided with a sound-absorbing cladding.

According to one exemplary embodiment, the turbofan engine has two independently controllable adjusting mechanisms that have axially displaceable rings and are provided and configured for the purpose of adjusting the outlet surface of the frontal adjustable inner wall area (which forms the nozzle throat surface) and the outlet surface of the rear adjustable inner wall area (which forms the nozzle outlet surface). Here, the adjustment of the frontal and rear adjustable inner wall areas by means of displaceable rings is to be understood to be merely an example. Alternatively, the adjustment can be carried out by means of other adjusting actuators, for example in the form of pistons, or the like.

In order to form the frontal adjustable inner wall area, the rear adjustable inner wall area, and the adjustable area of the outer wall, it can be provided that these are respectively comprised of a plurality of segments that are distributed about the circumference. For instance, respectively between 4 to 20, in particular 8 to 16, segments that are distributed around the circumference are provided.

According to one embodiment of the invention, the inner wall and the outer wall of the thrust nozzle taper off towards each other at the nozzle outlet edge. In this manner, any turbulence of the flow at the discharge edge is avoided, or at least reduced.

Here, it can be provided that the inner wall and the outer wall of the thrust nozzle are connected to each other through guide elements, for example a roller guide or a sliding guide, wherein the guide elements ensure that the inner wall and the outer wall taper off towards the discharge edge in every adjustment position of the thrust nozzle. In particular, it can be provided that the rear adjustable inner wall area and the rear adjustable area of the outer wall are connected to each other via guide elements.

To ensure that the nozzle outlet edge is configured so as to taper off, it is for example provided that the inner wall and the outer wall of the thrust nozzle have a small radial distance at the nozzle outlet edge, which is in the range of between 5 mm and 30 mm, in particular in the range of between 10 mm and 20 mm.

According to one embodiment of the invention, the thrust reverser that is integrated in the thrust nozzle is configured as an external thrust reverser, i.e. it is pivoted into a position behind the thrust nozzle if an actuation takes place. In one associated embodiment, it is provided that the thrust reverser has pivotable thrust reverser doors that are formed by the frontal non-adjustable area of the outer wall. Here, the frontal non-adjustable area of the inner wall remains in place and is not pivoted, i.e. the inner wall of the thrust nozzle is not adjusted by actuating the thrust reverser.

According to an alternative embodiment, the thrust reverser that is integrated in the thrust nozzle is configured as an internal thrust reverser, wherein the flow is guided sidewise, i.e. upwards and downwards from the thrust nozzle. For this purpose, it can for example be provided that the thrust reverser has rotatable thrust reverser doors that are formed by the inner wall and the outer wall of the frontal non-adjustable area of the thrust nozzle. After the thrust reverser doors have been rotated, the gas flow is thus deflected outwards in the thrust nozzle.

In a further embodiment of the invention, it is provided that, in the event that the thrust reverser is actuated, not only certain doors that are formed inside the thrust nozzle are pivoted or rotated (while other areas of the thrust nozzle are not affected by such a movement), but that in such a case the thrust nozzle is pivoted as a whole in order to provide a deflection of the flow. For this purpose, it can be provided that the thrust nozzle with the integrated thrust reverser has two frontal thrust reverser doors and two rear nozzle sections that are provided with an adjusting mechanism for adjusting the nozzle throat area and the nozzle outlet area, wherein the thrust reverser doors can be pivoted together with the rear nozzle sections for the purpose of extending the thrust reverser. Here, it can further be provided that the adjusting mechanism for adjusting the nozzle throat area and the nozzle outlet area comprises at least one eccentric that is mounted on the common rotational axis of the thrust reverser doors and the rear nozzle sections.

In a further embodiment, the thrust nozzle is configured to have a rectangular cross section at least in its adjustable area, and correspondingly forms two side walls, a lower wall and an upper wall, which are respectively configured in a planar manner. It is provided that only the upper and the lower wall are adjustable. Also in this exemplary embodiment, the thrust nozzle in its rear adjustable area is divided into two partial areas, a frontal and a rear adjustable partial area, i.e. the lower wall consists of two upper planar segments that are respectively adjustable, and the upper wall consists of two lower planar segments that are respectively adjustable. Here, apart from the inner wall of the thrust nozzle, the segments can also comprise the outer wall of the thrust nozzle. During an adjustment, the upper and the lower segment of the frontal adjustable area and/or the upper and lower segment of the rear adjustable area are moved towards or away from each other in the vertical direction. This embodiment has a particularly simple structure, as only planar segments have to be adjusted to provide an adjustment. Here, the vertical direction refers to an orientation in which the engine is attached at the aircraft.

Alternatively, the planar adjustable surfaces can be rounded at their sides towards the stationary walls. Further, the upper and the lower edge of the nozzle outlet surface can be embodied so as to be curved upwards or downwards, so the nozzle outlet surface may deviate from the rectangular cross section. In this way, an improved exterior surround-flow of the thrust nozzle can be achieved.

The turbofan engine comprises a multi-stage fan. According to one embodiment of the invention, it is configured so as to have great axial distances between the fan rotor-blades and the fan stator-blades for the purpose of noise reduction. Each fan stage of the multi-stage fan has a fan rotor and a fan stator. According to one embodiment, it is provided to apply to at least one fan rotor or fan stator that, in the radial flow center, the axial distance between the blades of a fan rotor or fan stator and the blades of the fan stator or fan rotor that is arranged directly upstream in the flow direction is between 60% and 150%, in particular between 80% and 130%, of the axial length of the blades of the fan stator or fan rotor that is arranged upstream.

For a double-stage fan this means that, in the radial flow center, the axial distance between the blades of the fan stator of the first stage to the blades of the fan rotor of the first stage is between 60% and 150%, in particular between 80% and 130%, of the axial length of the blades of the fan rotor, and/or that the axial distance between the blades of the fan rotor of the second stage to the blades of the fan stator of the first stage is between 60% and 150%, in particular between 80% and 130%, of the axial length of the blades of the fan stator of the first stage.

In a further embodiment of the invention, in order to achieve a better flow from the first fan stage to the second fan stage, the blade tip at the inlet edge (i.e. the axially frontal edge) of the second rotor stage of the fan is located radially further inside with respect to the machine axis by between 2% to 10%, in particular between 3% to 6%, than the blade tip at the inlet edge of the first rotor stage of the fan.

It can be provided that the stator blades of the fan are rotatable about their radial axis.

To reduce the air resistance of the engine nacelle, it is provided in one embodiment of the invention that the turbofan engine is arranged inside an engine nacelle with a circular or approximately circular cross section, wherein the engine nacelle has no local bulges for the gears and/or the ancillary units. Here, an approximately circular cross section is present if the radius along the circumference varies by not more than 10% of its maximal value. According to this embodiment variant, the invention thus provides a slim engine nacelle without local bulges.

In a further embodiment of the invention, it is provided that a reducing gear is provided in the drive train between a low-pressure turbine of the engine and the fan to reduce the rotational speed from a high-speed low-pressure turbine to the multi-stage fan. The reducing gear may for example be configured as a planetary gear.

Further, it can be provided that a nose cone, which is arranged upstream of the fan, is configured so as to be displaceable in the axial direction. The axially displaceable nose cone is for example held by means of a structure that is located axially in front of the fan rotor and that is supported at the fan housing or the engine intake. Based on the displaceability of the nose cone, the engine intake can be adjusted to different operational conditions. For instance, a complete extension of the nose cone at higher velocities from about Ma 1.5 can be provided.

The turbofan engine has a mixer that is arranged behind the core engine which mixes air of the primary flow channel and air of the secondary flow channel. According to one embodiment, it is provided that the mixer and/or an outlet cone of the engine are configured so as to be axially displaceable. For instance, a displaceability via positioning cylinders can be provided, which are arranged outside of the low-pressure turbine or outside the bypass flow housing and can for example be actuated through tilting levers. Here, it is provided that the mixer and/or the outlet cone are fully extended at sonic speed.

The present invention also relates to a civil supersonic aircraft with a turbofan engine according to the invention.

In one embodiment, it is provided that an auxiliary gearbox of the turbofan engine and/or the auxiliary devices driven by the auxiliary gearbox are at least partially mounted in a pylon and/or in the aircraft fuselage. By transferring the auxiliary gearbox and/or the auxiliary devices from the engine to the pylon and/or the aircraft fuselage, a slim nacelle with a low air resistance is facilitated.

### BRIEF DESCRIPTION OF THE DRAWINGS

The invention will be explained in more detail on the basis of exemplary embodiments with reference to the accompanying drawings in which:

FIG. 1 shows a partially sectioned view of an exemplary embodiment of a turbofan engine that has an external thrust reverser which is integrated into a thrust nozzle;

FIG. 2 shows an enlarged rendering of the thrust nozzle of FIG. 1;

FIG. 3 shows the thrust nozzle of FIG. 2 without exterior cladding elements;

FIG. 4 shows the thrust nozzle of FIG. 2 in a partially sectioned view;

FIG. 4a shows an enlarged rendering of the nozzle outlet edge of the thrust nozzle of FIG. 2 that is formed by an inner wall and an outer wall of the thrust nozzle that taper off towards the nozzle outlet edge;

FIG. 5 shows the thrust nozzle of FIG. 2 in a further rendering which shows the adjusting mechanism for adjusting the thrust nozzle;

FIG. 6 shows the thrust nozzle of FIG. 2 in a further rendering, in which the nozzle throat area is maximal and the nozzle outlet area is also maximal;

FIG. 7 shows the thrust nozzle of FIG. 2 in a further rendering, in which the nozzle throat area is minimal and the nozzle outlet area is maximal;

FIG. 8 shows the thrust nozzle of FIG. 2 in a further rendering, in which the nozzle throat area is minimal and the nozzle outlet area is also minimal;

FIG. 9 shows the thrust nozzle of FIG. 2 after the thrust reverser integrated inside the thrust nozzle has been actuated;

FIG. 10 shows an exemplary embodiment of a turbofan engine that has an internal thrust reverser which is integrated inside the thrust nozzle;

FIG. 11 shows a further exemplary embodiment of a turbofan engine that has a thrust reverser which is integrated inside the thrust nozzle, wherein the thrust nozzle has planar segments that are adjustable in the vertical direction;

FIG. 12 shows a further exemplary embodiment of a turbofan engine with a thrust nozzle and a thrust reverser integrated therein, wherein the turbofan engine has a reducing gear for reducing the fan's rotational speed;

FIG. 13 shows a further exemplary embodiment of a turbofan engine with a thrust nozzle and a thrust reverser integrated therein, wherein the turbofan engine has a nose cone that is adjustable in the axial direction;

FIG. 14 shows a further exemplary embodiment of a turbofan engine with a thrust nozzle and a thrust reverser integrated therein, wherein the turbofan engine has a mixer that is displaceable in the axial direction and/or an outlet cone that is displaceable in the axial direction;

FIG. 15 shows a further exemplary embodiment of a turbofan engine with a thrust nozzle and a thrust reverser integrated therein, wherein an adjusting mechanism is provided, which comprises an eccentric that is mounted on the pivot point of the thrust reverser doors;

FIG. 16 shows the turbofan engine of FIG. 15 with the thrust reverser opened; and

FIG. 17 shows, in a schematic and partially sectioned view from the front, the attachment of a turbofan engine at an aircraft fuselage.

### DETAILED DESCRIPTION

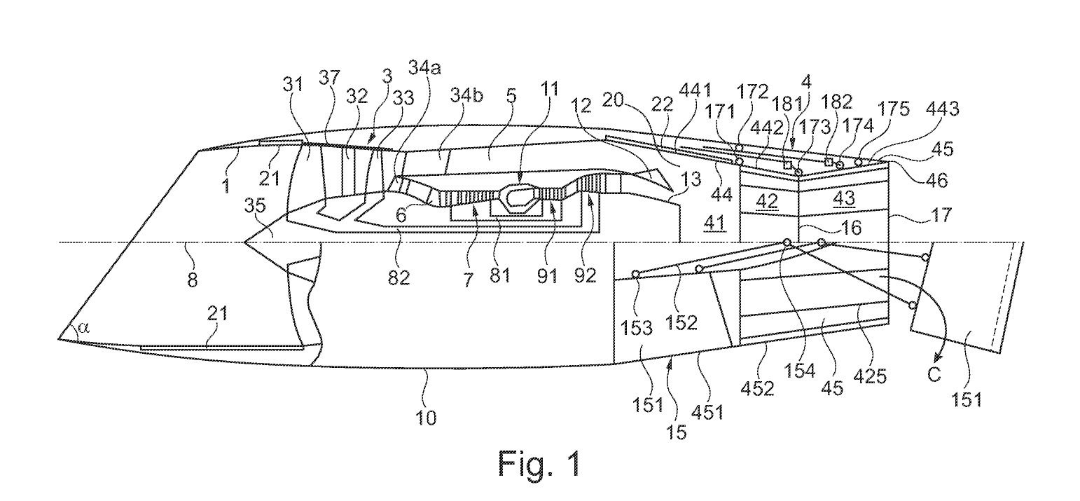

FIG. 1 shows a turbofan engine for a civil supersonic aircraft. The turbofan engine comprises an engine intake 1, a multi-stage fan 3, a primary flow channel 6 that leads through a core engine, a secondary flow channel 5 that leads past the core engine, a mixer 12, and a converging-diverging thrust nozzle 4 into which a thrust reverser 15 is integrated.

The turbofan engine has a machine axis or engine center line 8. The machine axis 8 defines an axial direction of the turbofan engine. A radial direction of the turbofan engine extends perpendicularly to the axial direction.

The core engine comprises in a per se known manner a compressor 7, a combustion chamber 11 and a turbine 91, 92. In the shown exemplary embodiment, the compressor comprises a high-pressure compressor 7. A low-pressure compressor is formed by the areas of the multi-stage fan rotor 3 that are located close to the hub. The turbine that is arranged behind the combustion chamber 11 comprises a high-pressure turbine 91 and a low-pressure turbine 92. The high-pressure turbine 91 drives a high-pressure shaft 81 that connects the high-pressure turbine 91 to the high-pressure compressor 7. The low-pressure turbine 92 drives a low-pressure shaft 82 that connects the low-pressure turbine 92 to the multi-stage fan 3.

The turbofan engine is arranged inside an engine nacelle 10. It is connected to the aircraft fuselage, for example via a pylon.

The engine intake 1 forms a supersonic air inlet and is correspondingly provided and suitable for slowing down the inflowing air to velocities of below Ma 1.0 (Ma=Mach number). In FIG. 1—but not necessarily—the engine intake is beveled, forming an angle α, wherein the lower edge projects with respect to the upper edge. This serves for a better upward distribution of compression shocks as they occur in supersonic flight. However, in principle the engine intake can be formed in a straight manner, i.e. with an angle α of 90°, or a different angle than the one shown.

The engine intake 1 has an interior cladding of a sound-absorbing material 21. This serves for reducing engine noise.

The fan 3 is formed as a multi-stage fan, in the shown exemplary embodiment as a double-stage fan. Accordingly, the multi-stage fan 3 comprises a fan rotor 31 and a fan stator 32 that form a first, frontal fan stage, as well as a fan rotor 33 and a fan stator 34a, 34b that form a second, rear fan stage. Upstream, the fan 3 is provided with a nose cone 35. The fan rotors 31, 33 respectively comprise a plurality of rotor blades. The fan stator 32 of the frontal fan stage comprises a plurality of stator blades that are mounted in a fan housing 37. The fan stator of the rear fan stage is split and is formed by a guide baffle 34a that is formed at the entry of the primary flow channel 6, and formed by a guide baffle 34b that is formed at the entry of the secondary flow channel 5.

It can be provided that the fan rotors 31, 33 are configured in BLISK design and are fixedly attached to each other.

Behind the fan rotor 33, the flow channel through the fan 3 is divided into the primary flow channel 6 and the secondary flow channel 5. Thus, both fan rotors 31, 33 are located upstream of the division of the flow channel into the primary flow channel 6 and the secondary flow channel 5. The secondary flow channel 5 is also referred to as the bypass flow channel or the bypass channel.

Behind the core engine, the primary flow inside the primary flow channel 6 and the secondary flow inside the secondary flow channel 5 are mixed by the mixer 12. Further, an outlet cone 13 is inserted behind the turbine to realize the desired cross sections of the flow channel.

The rear area of the turbofan engine is formed by a thrust nozzle 4 into which a thrust reverser 15 is integrated. The thrust nozzle 4 has a frontal non-adjustable area 41 and a rear adjustable area 42, 43, wherein the rear adjustable area is in turn divided into a frontal adjustable partial area 42 and a rear adjustable partial area 43.

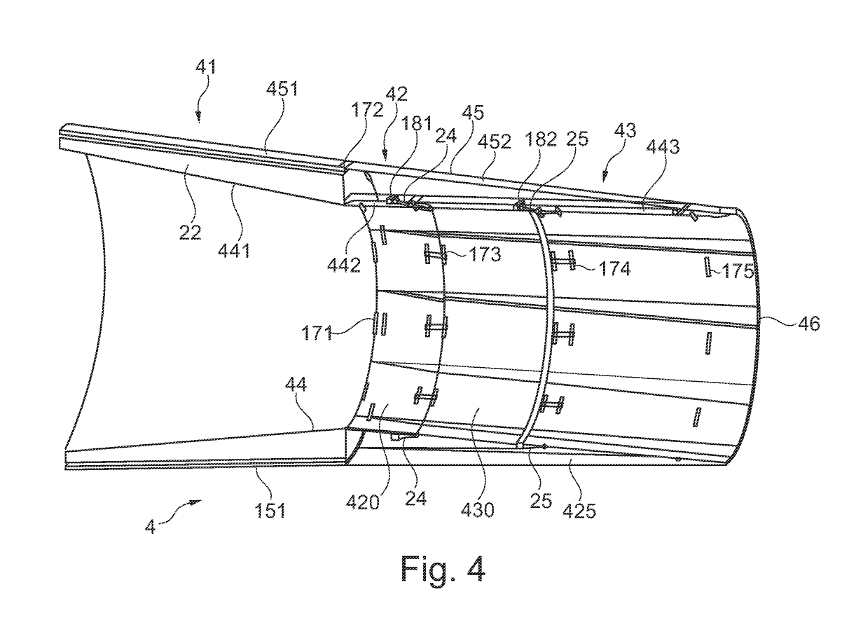

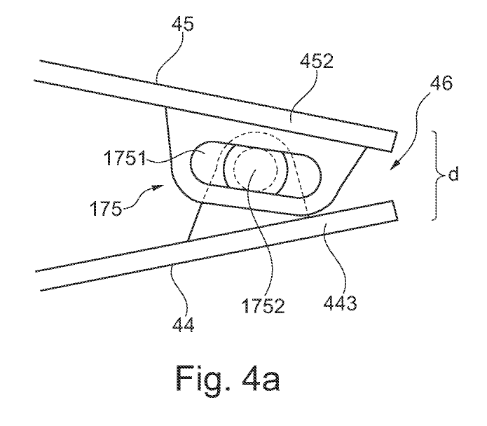

Structurally, the thrust nozzle is formed by an inner wall 44 and an outer wall 45. At that, the inner wall 44 forms the boundary of the flow channel 20 in the thrust nozzle 4. The outer wall 45 is configured radially outside with respect to the inner wall 44 and borders the environment. The inner wall 44 and the outer wall 45 taper off towards each other downstream, forming a nozzle outlet edge 46 at their downstream end, as will be explained based on FIG. 4a.

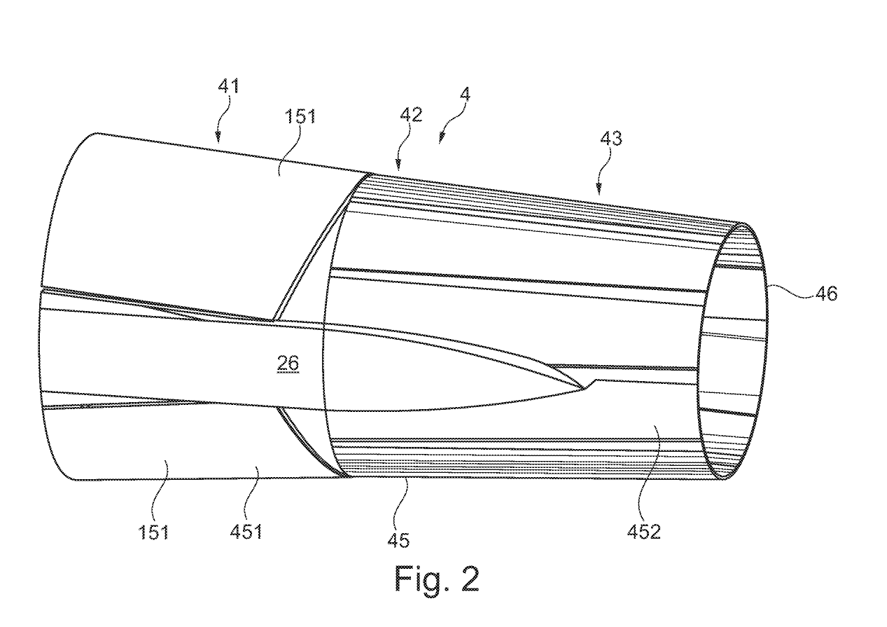

The following explanation additionally refers to FIGS. 2 to 4, which show the thrust nozzle 4 of FIG. 1 in an enlarged rendering and in different views. The frontal non-adjustable area 41 of the thrust nozzle 4 comprises a frontal non-adjustable area 451 of the outer wall 45 and a frontal non-adjustable area 441 of the inner wall 41 (cf. FIG. 4). The rear adjustable area 42, 43 of the thrust nozzle 4 comprises a rear adjustable area 452 of the outer wall 45 and a rear adjustable area 442, 443 of the inner wall 44, wherein the rear adjustable area of the inner wall has a frontal adjustable inner wall area 442 and a rear adjustable inner wall area 443 (cf. FIG. 4). Here, the inner wall area 442 is configured in the area 42, and the inner wall area 443 is configured in the area 43 of the thrust nozzle 4.

The rear adjustable inner wall area 443 is connected to the frontal adjustable inner wall area 442 via hinge joints 173. The frontal adjustable inner wall area 442 is connected to the frontal non-adjustable area 441 of the inner wall 44 via hinge joints 171. Likewise, the rear adjustable area 452 of the outer wall 45 and the frontal non-adjustable area 451 of the outer wall 45 are connected via hinge joints 172.

As is shown in FIG. 1 and in particular in FIG. 4, in the frontal non-adjustable area 441, the inner wall 44 is provided with a sound-absorbing cladding 22 that serves for noise reduction.

The converging-diverging thrust nozzle 4 has an adjustable nozzle throat area 16 and an adjustable nozzle outlet area 17. The nozzle throat area 16 is the narrowest cross-sectional surface of the flow channel through the thrust nozzle 4. It is realized at the rear end of the area 42 of the thrust nozzle 4. The nozzle outlet area 17 defines the cross-sectional area at the nozzle outlet, i.e. at the nozzle outlet edge 46.

For adjusting the nozzle throat area 16 and the nozzle outlet area 17, two independently controllable adjusting mechanisms are provided, which respectively have an axially displaceable ring 181, 182 and a plurality of hinges. As is in particular shown in FIG. 4, a frontal adjusting ring 181 is provided, which is coupled to the hinge joints 173 via tilting levers 24. The nozzle throat area 16 can be adjusted by means of an axial displacement of the adjusting ring 181. In a corresponding manner, a rear adjusting ring 182 is provided, which is coupled to hinge joints 174 via tilting levers 25. The nozzle outlet area 17 can be adjusted by means of an axial displacement of the adjusting ring 182.

As can be further seen from FIG. 4, the frontal adjustable inner wall area 442, the rear adjustable inner wall area 443, and the adjustable area 452 of the outer wall 45 respectively consist of a plurality of segments 420, 430, 425 that are distributed about the circumference. For instance, respectively between 4 and 20, in particular between 8 and 16, segments 420, 430, 425 distributed about the circumference are provided. The segments 425 of the rear area 452 of the outer wall 45 are also shown in the lower half of FIG. 1, in which the engine is shown in a non-sectioned manner.

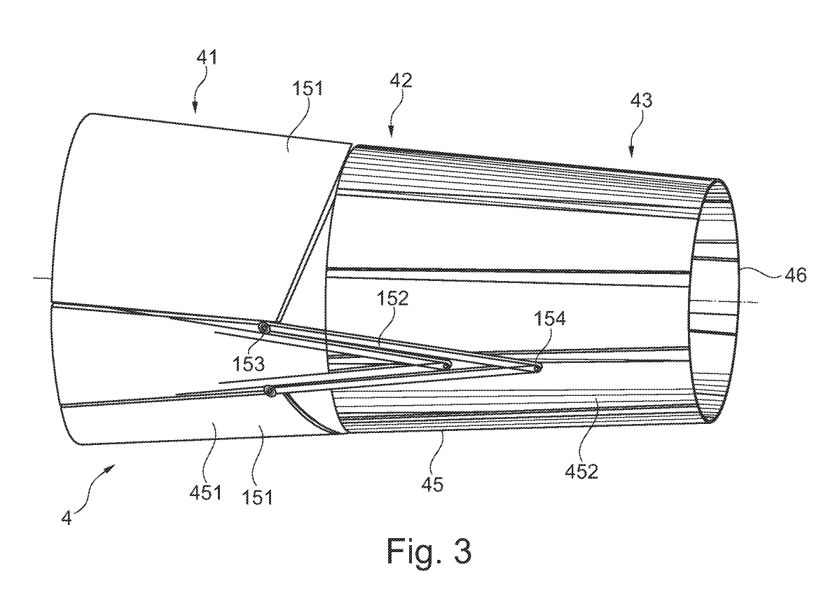

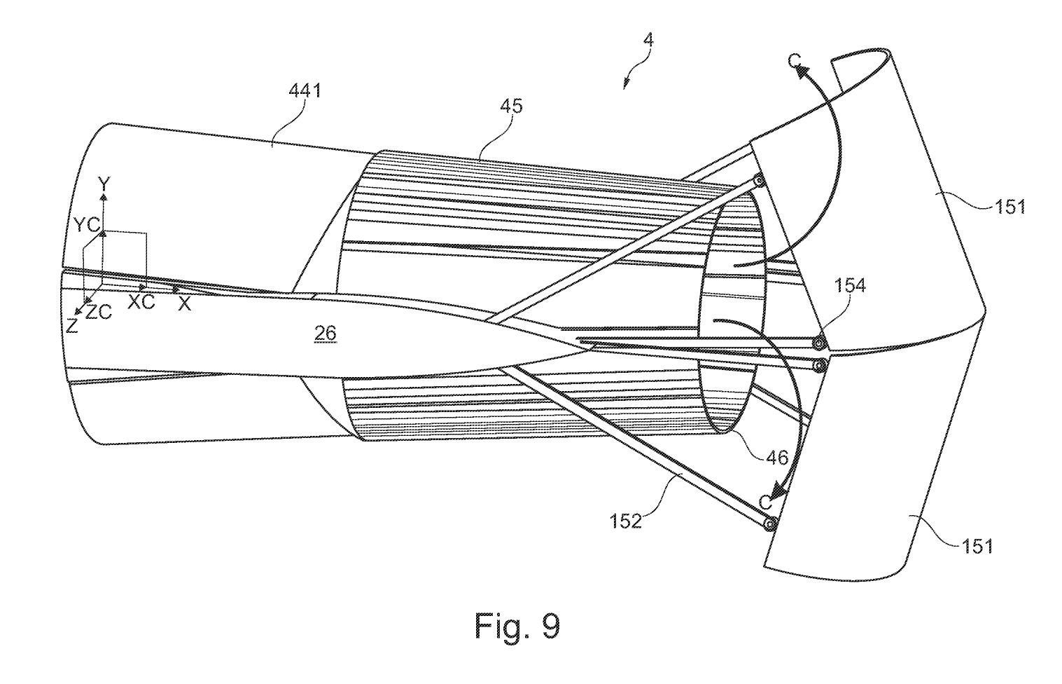

According to the present invention, the thrust reverser 15 is integrated into the thrust nozzle 4. The thrust reverser 15 comprises two thrust reverser doors 151 that are formed by sections in the frontal non-adjustable area 451 of the outer wall 45. The thrust reverser 15 is shown in FIGS. 1 to 4 in the retracted state. For pivoting the thrust reverser doors 151, tilting levers 152 are provided, which are mounted at pivot points 153, 154 at the thrust reverser doors 151 and at the thrust nozzle 4, cf. FIGS. 1 and 3. In the extended state, cf. FIG. 1, the thrust reverser doors 151 are folded behind the nozzle outlet edge 46 and deflect the gases that are discharged from the thrust nozzle 4 in a manner corresponding to the arrows C. Here, the thrust nozzle is still formed in the frontal area 41 by the frontal non-adjustable area 441 of the inner wall (cf. FIG. 4). The extended state will be explained further based on FIG. 9.

It is also pointed out that FIG. 2 shows the cladding 26 of the tilting lever 152, which is not shown in FIG. 3.

In the following, the configuration of the nozzle outlet edge 46 is described based on FIG. 4a. At the nozzle outlet edge 46, the inner wall 44 tapers off at its rear adjustable internal area 443 and the outer wall 45 tapers off at its rear adjustable area 452. Here, a sliding guide 175 is provided, which connects the two walls 452, 443 with each other in a movable manner. The sliding guide 175 comprises a bearing element 1752 that is connected to the wall 443 and is guided inside an elongated hole 1751 which is connected to the wall 452. Through the adjustability of the rear area 452 of the outer wall 45, it is ensured that the inner wall 44 and the outer wall 45 taper off towards the nozzle outlet edge 46 in every adjustment position of the thrust nozzle, and thus under all flight conditions. Here, the radial distance d between the most widely spaced apart edges of the inner wall 44 and the outer wall 45 at the nozzle outlet edge 46 is in the range of between 5 mm and 30 mm, in particular in the range of between 10 mm and 20 mm.

By providing a nozzle outlet edge 46 that tapers off at every flight condition, turbulences in the flow at the nozzle outlet edge 46 are for the most part avoided.

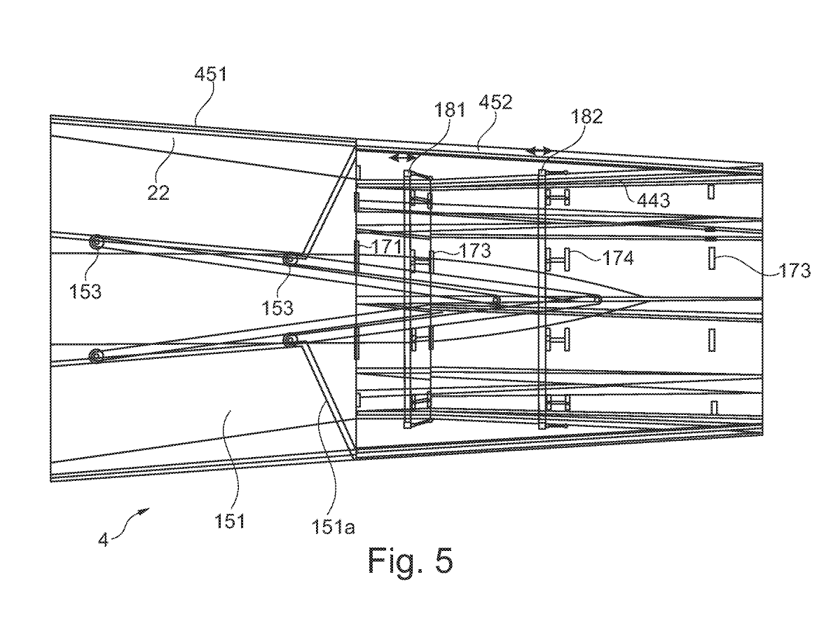

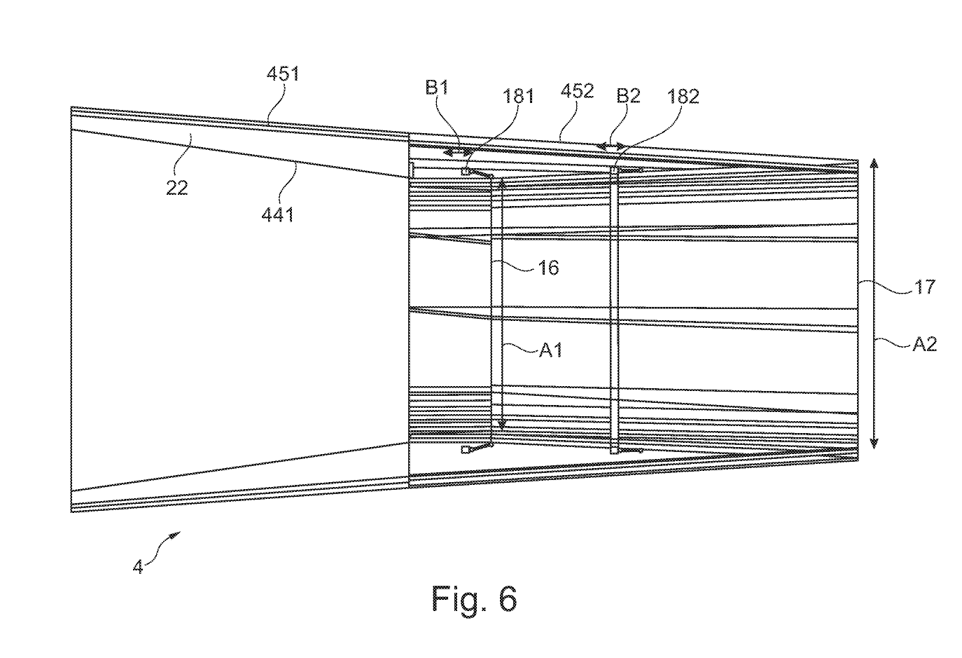

FIGS. 5 to 8 serve for further explaining of the thrust nozzle 4 shown in FIGS. 1 to 4. FIG. 5 additionally shows rims 151a, which the thrust reverser doors 151 form opposite such areas of the outer wall 451 that are pivoted during the extension of the thrust reverser. Further, the adjusting rings 181, 182 that have already been explained can be clearly seen. FIG. 6 additionally shows the nozzle throat area 16 that is adjustable through the adjusting ring 181, and the nozzle outlet area 17 that is adjustable through the adjusting ring 182, wherein their dimensions are indicated by the arrows A1 and A2. The axial adjustment range of the adjusting rings 181, 182 is indicated by arrows B1, B2. Here, FIG. 6 shows a position of the adjusting rings 181, 182, in which the nozzle throat area 16 and the nozzle outlet area 17 are maximal.

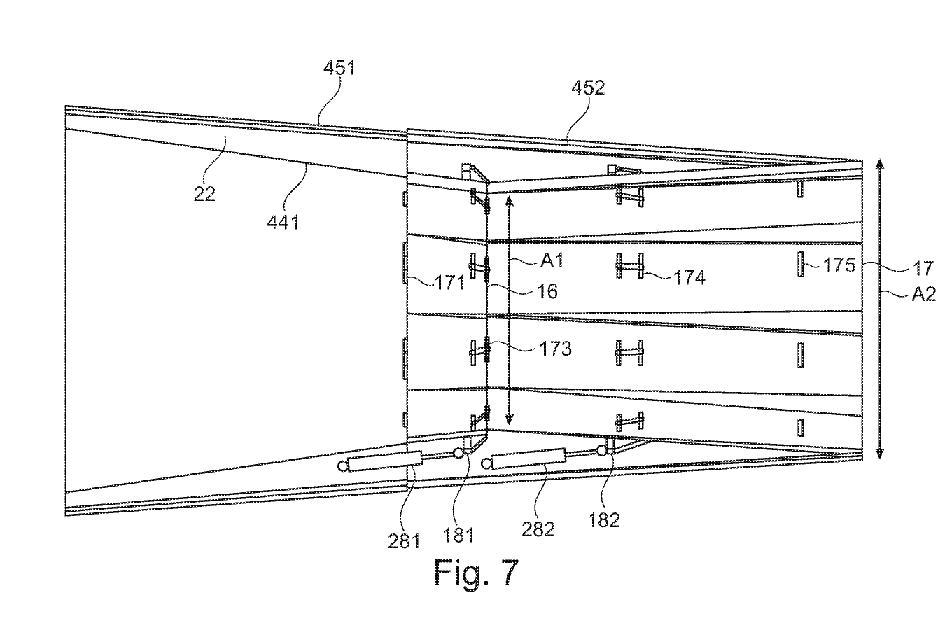

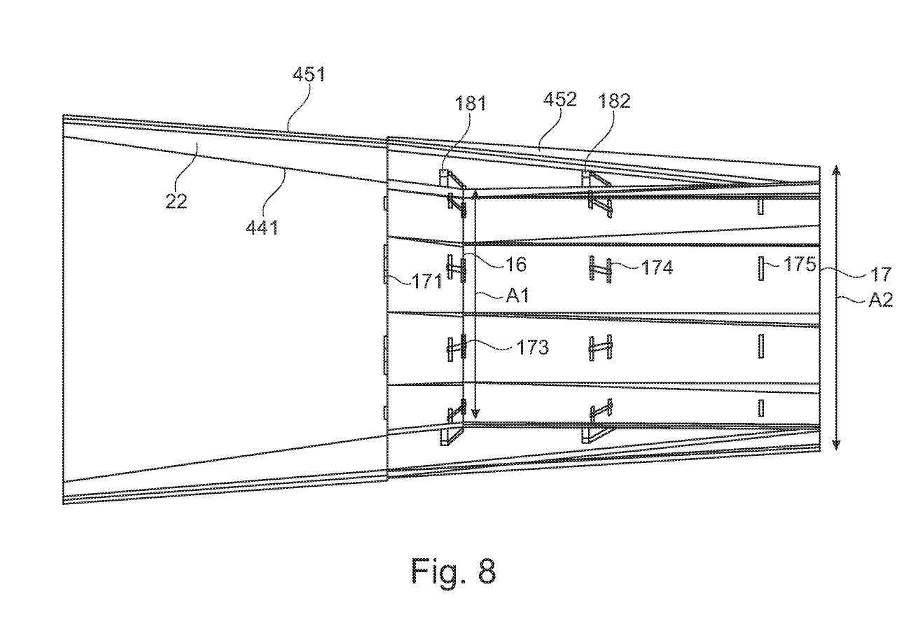

In the rendering of FIG. 7, two positioning cylinders 281, 282 for adjusting the frontal adjusting ring 181 and for adjusting the rear adjusting ring 182 are additionally shown. Here, FIG. 7 shows a position of the adjusting rings 181, 182, in which the nozzle throat area 16 is minimal and the nozzle outlet area 17 is maximal. In FIG. 8, the adjusting rings 181, 182 are shown with the nozzle throat area 16 as well as the nozzle outlet area 17 being minimal.

FIG. 9 shows the thrust nozzle 4 with the thrust reverser folded out, wherein the thrust reverser doors 151 have been pivoted to behind the discharge edge 46. Gases that are discharged form the thrust nozzle 4 are diverted according to the arrows C in order to realize a thrust reverser function.

In the activated state, the frontal non-adjustable area 441 of the inner wall can be seen in the exterior view, as the outer wall that is arranged above it in the retracted state and forms the thrust reverser doors 151 has been pivoted out of the way.

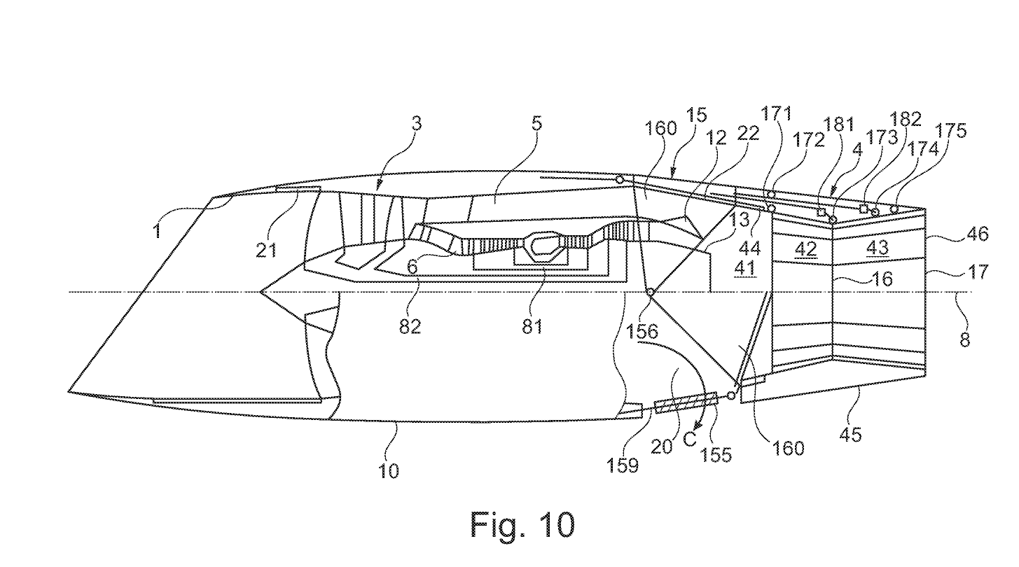

FIG. 10 shows an alternative exemplary embodiment, in which—in contrast to FIGS. 1 to 9—the thrust reverser is configured as an internal thrust reverser 15. Here, the exemplary embodiment of FIG. 10 differs from the exemplary embodiment of FIGS. 1 to 9 only with regard to the embodiment of the thrust reverser 15. The structure of the thrust nozzle 4 as a converging-diverging thrust nozzle with an inner wall 44 and an outer wall 45, with a frontal non-adjustable area 41 and a rear adjustable area with partial areas 42, 43 remains the same, so that the explanations pertaining to FIGS. 1 to 9 may be referred to in this regard, as they apply in a corresponding manner. Also, the rest of the structure of the engine remains unchanged, with the exception of the configuration of the thrust reverser 15.

In the exemplary embodiment of FIG. 10, the thrust reverser 15 forms thrust reverser doors 160 that are rotatable about a common rotational axis 156 which is located on the machine axis 8. Here, the thrust reverser doors 160 comprise sections of the frontal non-adjustable area of the outer wall 45 as well as of the frontal non-adjustable area of the inner wall 44. When the thrust reverser doors 160 are rotated about the rotational axis 156, they are rotated in such a manner that they block the flow channel 20, cf. the lower half of the illustration of FIG. 10, so that the flow is laterally deflected according to the arrow C. Here, it can be provided that the thrust reverser doors 160 are additionally provided with a guide baffle 155 for deflecting the flow according to the arrows C. At that, the thrust reverser doors 160 can be actuated by means of coupling rods 159, for example.

The inner wall 44 is provided with a sound-absorbing material in the frontal non-adjustable area.

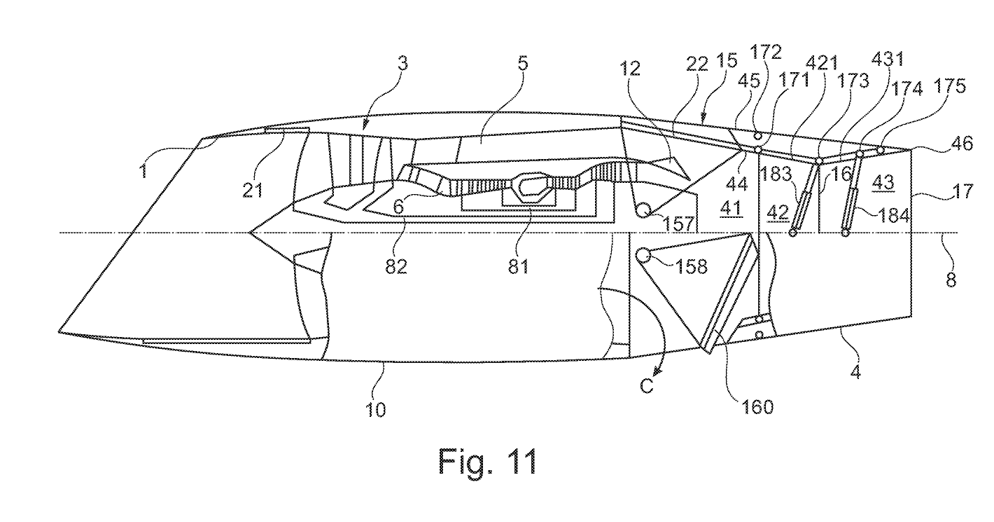

The exemplary embodiment of FIG. 11 also shows a thrust nozzle 4 with an internal thrust reverser 15. There are two differences to the exemplary embodiment of FIG. 10. For one thing, the two thrust reverser doors 160 do not rotate about a common rotational axis, but respectively about their own rotational axes 157, 158, with both of them not being located on the machine axis 8.

For another thing, the structure of the converging-diverging nozzle is different. It has a rectangular cross section at least in the adjustable partial areas 42, 43. Accordingly, it forms two side walls in the partial areas 42, 43, a lower wall and an upper wall, which are respectively configured in a planar manner at least in the adjustment range of the adjustable partial areas 42, 43. Only the upper and the lower wall are adjustable. The side walls are not adjustable. The lower wall has a planar upper segment 421 in the frontal adjustable partial area 42 and a planar upper segment 431 in the rear adjustable partial area 43. In a corresponding manner, the upper wall has a planar lower segment in the frontal adjustable partial area 42 and a planar lower segment in the rear adjustable partial area 43, which are not visible in the partially sectioned view of FIG. 11. Thus, the frontal adjustable partial area 42 and the rear adjustable partial area 43 respectively have a planar upper adjustable segment 421, 431 and a planar lower adjustable segment. At that, apart from the inner wall 44 of the thrust nozzle, the segments 421, 431 can also comprise the outer wall 45 of the thrust nozzle.

For adjusting the nozzle throat area 16, the planar upper segment 421 and the corresponding planar lower segment are moved towards each other or away from each other in the vertical direction. For adjusting the nozzle outlet area 17, the planar upper segment 431 and the corresponding planar lower segment are moved towards each other or away from each other in the vertical direction. For this purpose, adjusting actuators 183, 184 are provided, which are for example configured as positioning cylinders.

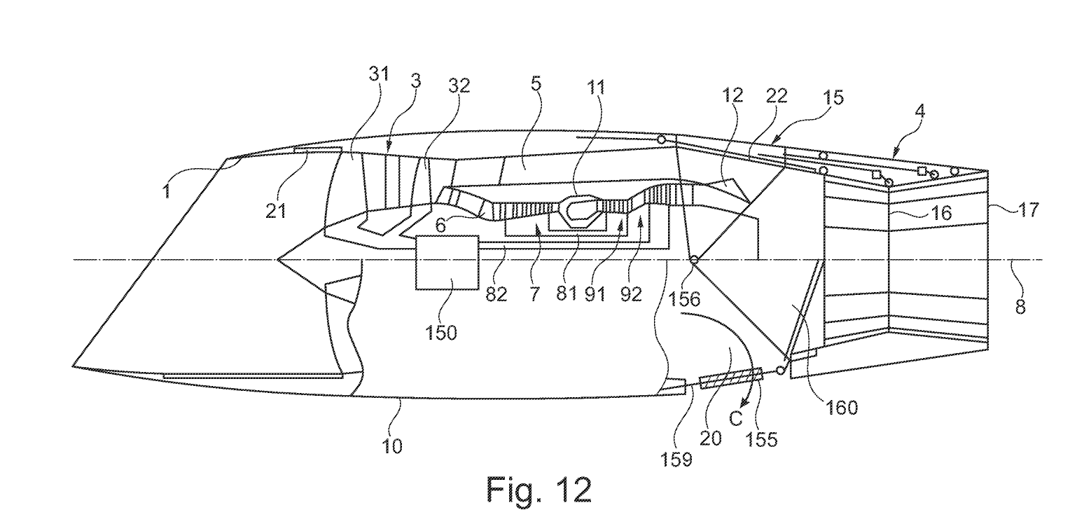

FIG. 12 shows an exemplary embodiment that is based on the exemplary embodiment of FIG. 10, but could also be based on any other of the shown exemplary embodiments. In FIG. 12, a reducing gear 150 is additionally provided, coupling the low-pressure shaft 82 with the fan 3. The reducing gear is for example embodied as a planetary gear embodied, and leads to a reduction of the fan's rotational speed as a result of the rotational speed of the high-speed low-pressure turbine 92 or the low-pressure shaft 82 being reduced to the multi-stage fan 3.

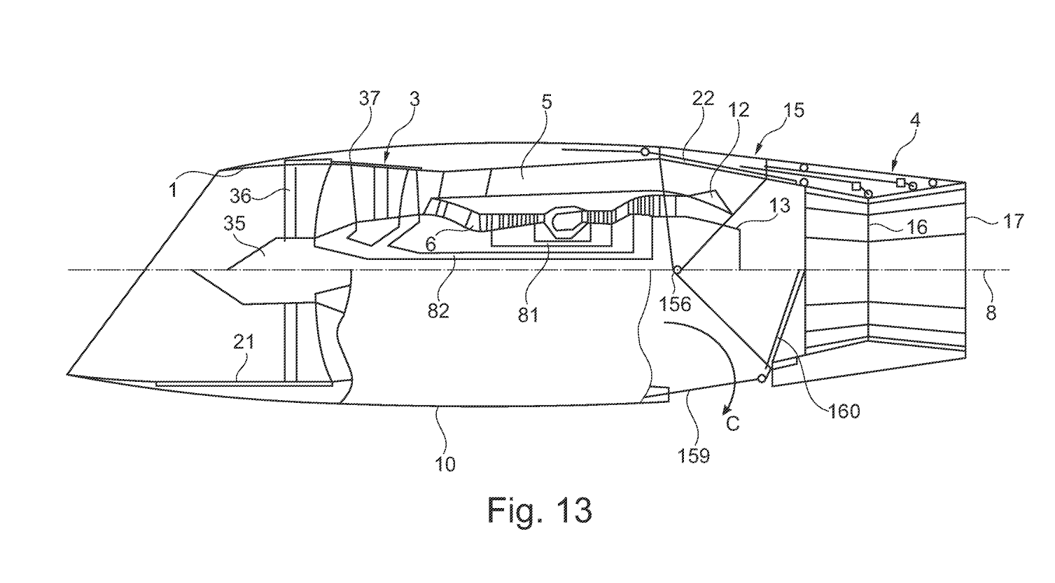

FIG. 13 shows an embodiment variant in which the nose cone 35 is configured so as to be adjustable in the axial direction. Here, two different axial positions are shown in FIG. 13, namely a position in which the nose cone 35 is retracted and a position in which the nose cone 35 is extended. At that, the displaceable nose cone 35 is supported through a radial structure 36 that is located axially in front of the fan rotor 3, and that is in turn supported at the engine intake 1 or at the fan housing 37. The nose cone 35 is extended at high velocities, in particular at velocities above Ma 1.5.

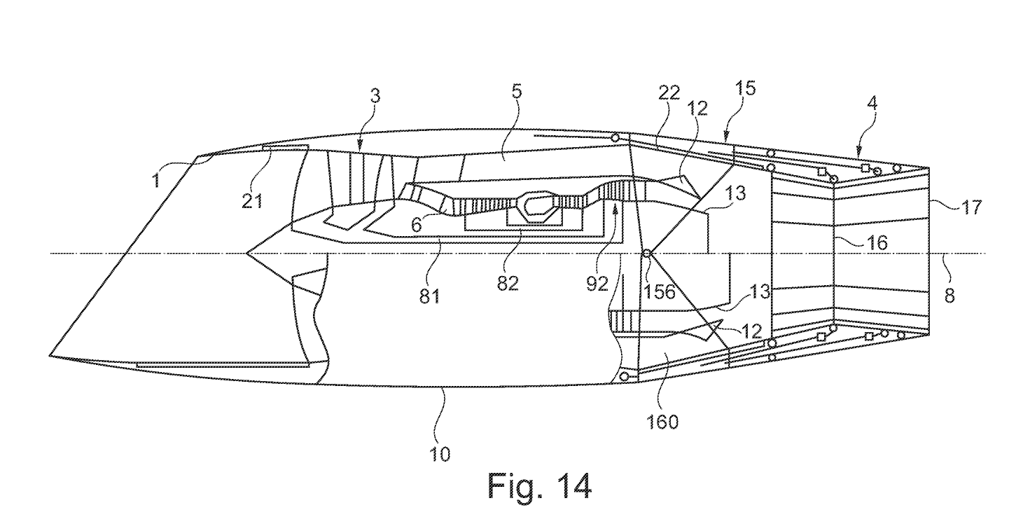

FIG. 14 shows an embodiment variant in which the mixer 12 and the outlet cone 13 are longitudinally displaceable in the axial direction. The upper half of FIG. 14 shows the mixer 12 and the outlet cone 13 in the retracted state. The lower half of FIG. 14 shows the mixer 12 and the outlet cone 13 in the extended state. For moving these components, cylinders, which are not shown, can for example be provided, with the cylinders being arranged outside of the low-pressure turbine 92 and being adjustable, for example by means of tilting levers. It is provided that at sonic speed the mixer 12 and the outlet cone 13 are completely extended.

The exemplary embodiments of FIGS. 13 and 14 are also based on the exemplary embodiment of FIG. 10. However, an adjustable nose cone 35 or an adjustable mixer 12 and outlet cone 13 can also be realized in any other exemplary embodiment.

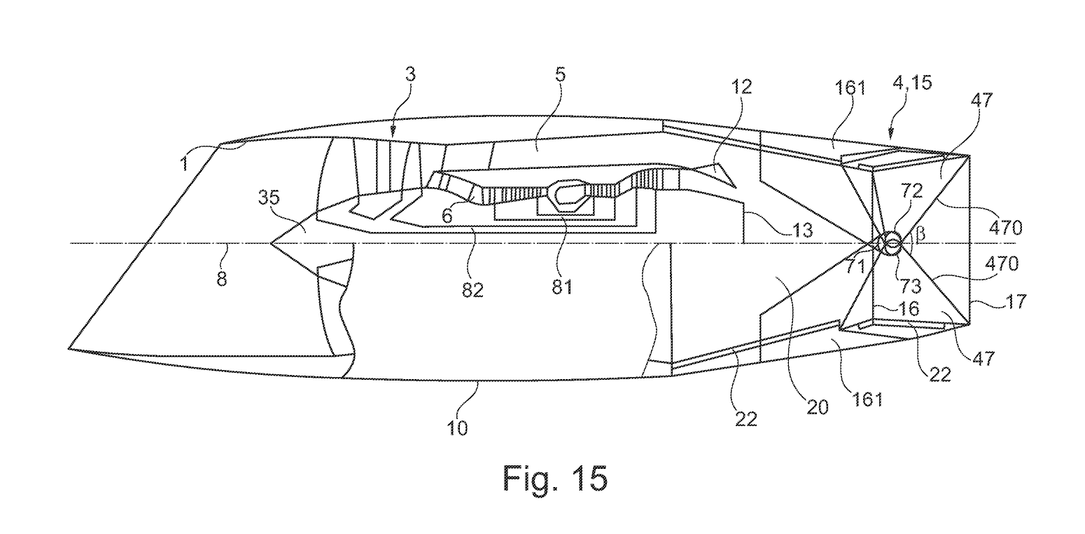

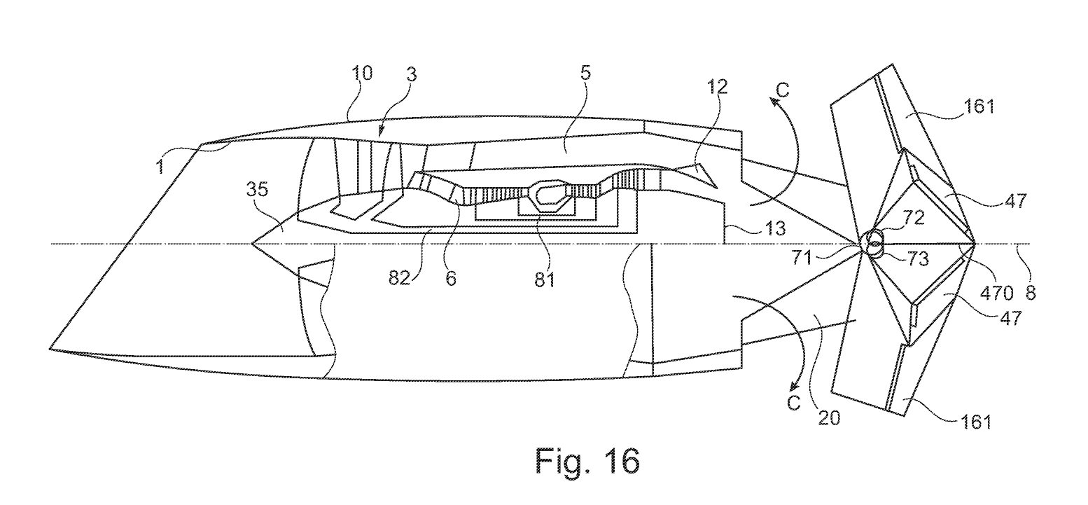

FIGS. 15 and 16 show an exemplary embodiment which differs from the exemplary embodiments explained so far in that the rear area of the nozzle 4, which facilitates adjusting the nozzle throat area 16 and the nozzle outlet area 17, also participates in a tilting movement when the thrust reverser 15 is extended.

The thrust nozzle 4 or the thrust reverser 15 comprise two rotatable thrust reverser doors 161 and two rotatable rear nozzle sections 47. These parts are mounted by means of three eccentrics 71, 72, 73. The eccentric 71 comprises a large eccentric circle and provides a rotational axis for both thrust reverser doors 161 and both nozzle sections 47. The two eccentrics 72, 73 respectively have a smaller eccentric circle that is positioned inside the larger eccentric circle and serves for mounting one of the nozzle sections 47, respectively.

For one thing, the nozzle sections 47 can be tilted, whereby the nozzle outlet area 17 can be adjusted. The nozzle sections 47 can further be moved outwards via respective eccentrics 72, 73, whereby the nozzle throat area 16 can be adjusted. As shown in FIG. 16, the two thrust reverser doors 161 as well as the two nozzle sections 47 can also be pivoted as a whole about the axis provided by the eccentric 71, wherein the flow channel 20 is blocked and the hot gases are deflected corresponding the arrows C when the thrust reverser is extended.

To ensure that the two nozzle sections 47 can be pivoted according to FIG. 16, it is necessary that their discharge edges taper off towards each other in a suitable manner. In the retracted state of the thrust reverser 15, the discharge edges 470 of the nozzle sections 47 are arranged at an angle β to each other in the side view of FIG. 15. If the thrust reverser 15 is extended and the nozzle sections 47 are pivoted, the discharge edges 470 come to abut each other, thus closing the flow channel 20, cf. FIG. 16.

The surfaces of the thrust reverser 15 and of the adjusting nozzle 4 that are facing towards the flow channel 20 are lined with a sound-absorbing material 22.

The turbofan engine is configured in such a manner in all embodiments of the invention that it has a comparatively low air resistance. For this purpose, it has a circular or approximately circular cross section. Also, it has no local bulges that serve for receiving an auxiliary gearbox or auxiliary devices. In this manner, it is provided that an auxiliary gearbox and corresponding auxiliary devices are completely or at least mostly transferred from the engine and integrated into the pylon that connects the engine to the aircraft fuselage, and/or into the aircraft fuselage.

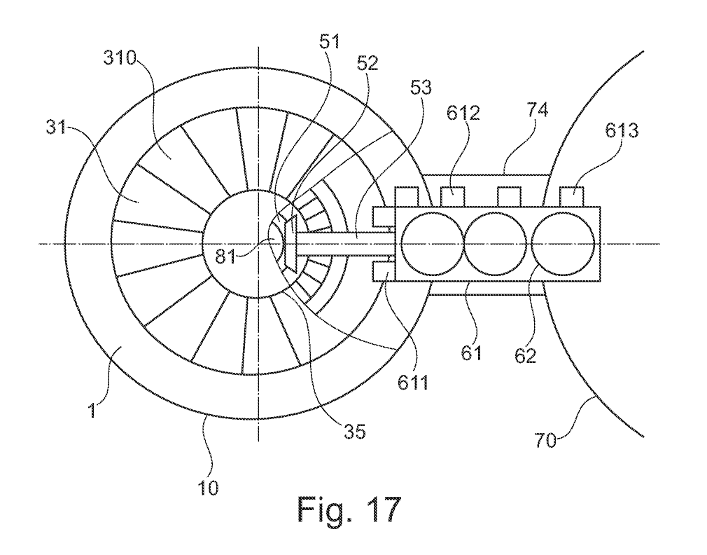

A corresponding exemplary embodiment is shown in FIG. 17, which shows the engine in a partially sectioned view from the front. What can be seen of the turbofan engine are the engine nacelle 10, the engine intake 1, the nose cone 35 and the foremost fan rotor 31 of the multi-stage fan, wherein the fan blades 310 of the fan rotor 31 are shown. The engine nacelle 10 has a circular cross section. The engine is connected to the aircraft fuselage 70 via a pylon 74. An auxiliary gearbox 61, which serves for driving and mounting a plurality of auxiliary devices 62, is arranged and mounted in the pylon 74 and in the aircraft fuselage 70. Thus, the auxiliary gearbox 61 has mounting brackets 611 towards the engine, mounting brackets 612 in the pylon 74, and mounting brackets 613 in the aircraft fuselage 70. The auxiliary devices 62 are arranged in the pylon 74 and/or in the aircraft fuselage 70.

For driving the auxiliary gearbox 61, it is coupled in a per se known manner to the high-pressure shaft 81 of the engine via a radial output shaft 53, a bevel gear 52 on the radial output shaft 53, and a bevel gear 51.

The described arrangement facilitates the realization of a slim, circular symmetric nacelle with a reduced air resistance.

The present invention is not limited in its embodiment to the above-described exemplary embodiments, which are to be understood merely as examples. For instance, the type of adjustability of the adjustable converging-diverging thrust nozzle is to be understood to be merely an example.

It is furthermore pointed out that the features of the individually described exemplary embodiments of the invention can be combined in various combinations with one another. Where areas are defined, they include all the values within these areas and all the sub-areas falling within an area.

What is claimed is:

1. Turbofan engine for a civil supersonic aircraft, comprising:
an engine intake that is provided and configured for slowing down the inflowing air during supersonic flight to velocities below the sonic speed,
a multi-stage fan that is arranged behind the engine intake,
a core engine that comprises a compressor, a combustion chamber, and a turbine,
a primary flow channel that leads through the core engine,
a secondary flow channel that leads past the core engine,
an adjustable converging-diverging thrust nozzle that forms a nozzle throat area and a nozzle outlet surface, wherein at least the nozzle throat area is adjustable, and
a thrust reverser that is integrated into the adjustable converging-diverging thrust nozzle.

2. Turbofan engine according to claim 1, wherein the thrust nozzle has a frontal upstream non-adjustable area and a rear downstream adjustable area, wherein the rear downstream adjustable area comprises a frontal adjustable partial area and a rear adjustable partial area.

3. Turbofan engine according to claim 2, wherein the thrust nozzle comprises an inner wall and an outer wall, wherein the frontal upstream non-adjustable area of the thrust nozzle comprises a frontal non-adjustable area of the outer wall and a frontal non-adjustable area of the inner wall, wherein the rear downstream adjustable area of the thrust nozzle comprises a rear adjustable area of the outer wall and a rear adjustable area of the inner wall, and wherein the rear adjustable area of the inner wall has a frontal adjustable inner wall area and a rear adjustable inner wall area.

4. Turbofan engine according to claim 3, wherein the thrust nozzle is provided with a sound-absorbing cladding in the frontal non-adjustable area of the inner wall.

5. Turbofan engine according to claim 3, further comprising two independently controllable adjusting mechanisms that comprise axially displaceable rings and are provided and configured for adjusting the outlet surface of the frontal adjustable inner wall area which forms the nozzle throat area, and the outlet area of the rear adjustable inner wall area which forms the nozzle outlet area.

6. Turbofan engine according to claim 3, wherein the frontal adjustable inner wall area, the rear adjustable inner wall area, and the adjustable area of the outer wall respectively consist of a plurality of segments that are distributed about the circumference.

7. Turbofan engine according to claim 2, wherein the frontal adjustable partial area and the rear adjustable partial area of the thrust nozzle are configured with a rectangular cross section and respectively have a planar upper adjustable segment and a planar lower adjustable segment, wherein the planar upper segment and the planar lower segment of the frontal adjustable partial area as well as the planar upper segment and the planar lower segment of the rear adjustable partial area are movable in the vertical direction towards each other or away from each other for providing adjustability of the thrust nozzle.

8. Turbofan engine according to claim 3, wherein the inner wall and the outer wall taper off at the nozzle outlet edge in every adjustment position of the thrust nozzle.

9. Turbofan engine according to claim 8, wherein the inner wall and the outer wall of the thrust nozzle are connected to each other by sliding guides which ensure that the inner wall and the outer wall taper off at the nozzle outlet edge in every adjustment position of the thrust nozzle.

10. Turbofan engine according to claim 8, wherein the inner wall and the outer wall of the thrust nozzle have a radial distance at the nozzle outlet edge that is in the range of between 5 mm and 30 mm, in particular in the range of between 10 mm and 20 mm.

11. Turbofan engine according to claim 2, wherein the thrust reverser is integrated in the frontal non-adjustable area of the thrust nozzle.

12. Turbofan engine according to claim 1, wherein the thrust reverser is configured as an external thrust reverser.

13. Turbofan engine according to claim 3, wherein the thrust reverser is configured as an external thrust reverser, wherein the thrust reverser has pivoted thrust reverser doors that are formed by the frontal non-adjustable area of the outer wall.

14. Turbofan engine according to claim 1, wherein the thrust reverser is configured as an internal thrust reverser.

15. Turbofan engine according to claim 3, wherein the thrust reverser is configured as an internal thrust reverser, wherein the thrust reverser has rotatable thrust reverser doors that are formed by the inner wall and the outer wall of the frontal non-adjustable area of the thrust nozzle.

16. Turbofan engine according to claim 1, wherein the thrust nozzle with the integrated thrust reverser has two frontal thrust reverser doors and two rear nozzle sections that are provided with an adjusting mechanism for adjusting the nozzle throat area and the nozzle outlet area, wherein the thrust reverser doors can be pivoted together with the rear nozzle sections in order to extend the thrust reverser.

17. Turbofan engine according to claim 16, wherein the adjusting mechanism for adjusting the nozzle throat area and the nozzle outlet area comprises at least one eccentric that is mounted on the common rotational axis of the thrust reverser doors and the rear nozzle sections.

18. Turbofan engine according to claim 1, wherein the converging-diverging thrust nozzle forms an adjustable nozzle throat area and an adjustable nozzle outlet area.

19. Turbofan engine according to claim 1, wherein the engine intake is provided with a sound-absorbing cladding.

20. Turbofan engine according to claim 1, wherein the turbofan engine is arranged in an engine nacelle with a circular or approximately circular cross section, and the engine nacelle has no local bulges for gears and/or auxiliary units.

21. Turbofan engine according to claim 1, wherein a nose cone that is arranged upstream of the multi-stage fan is configured so as to be displaceable in the axial direction.

22. Turbofan engine according to claim 1, further comprising a mixer that is arranged behind the low-pressure turbine and that mixes air of the primary flow channel and air of the secondary flow channel, wherein the mixer and/or an outlet cone of the engine are configured so as to be axially displaceable.

23. Turbofan engine according to claim 1, wherein it applies to at least one fan rotor or fan stator that, in the radial flow center of the flow channel through the fan, the axial distance between the blades of a fan rotor or fan stator and the blades of the fan stator or fan rotor that is arranged directly upstream in the flow direction is between 60% and 150%, in particular between 80% and 130%, of the axial length of the blades of the fan stator or the fan rotor arranged upstream.

24. Turbofan engine according to claim 1, wherein the blade tip at the inlet edge of the second rotor stage of the fan is located radially further inside with respect to the machine axis by between 2% to 10%, in particular by between 3% to 6%, than the blade tip at the inlet edge of the first rotor stage of the fan.

25. Civil supersonic aircraft with a turbofan engine according to claim 1.

26. Supersonic aircraft according to claim 25, wherein an auxiliary gearbox of the turbofan engine and/or the auxiliary devices that are driven by the auxiliary gearbox are mounted at least partially in a pylon and/or in the aircraft fuselage.
